(19) United States
(12) Patent Application Publication
(10) Pub. No.: US 2025/0278182 A1
(43) Pub. Date: Sep. 4, 2025

(54) CONTENT SHARING METHOD AND APPARATUS, ELECTRONIC DEVICE, AND READABLE STORAGE MEDIUM

(71) Applicant: VIVO MOBILE COMMUNICATION CO., LTD., Dongguan (CN)

(72) Inventor: Xin SUN, Dongguan (CN)

(73) Assignee: VIVO MOBILE COMMUNICATION CO., LTD., Dongguan (CN)

(21) Appl. No.: 19/209,780

(22) Filed: May 15, 2025

Related U.S. Application Data
(63) Continuation of application No. PCT/CN2023/132896, filed on Nov. 21, 2023.

(30) Foreign Application Priority Data
Nov. 25, 2022 (CN) 202211490278.2

(51) Int. Cl. G06F 3/04845; G06F 3/04817; H04L 51/52

(52) U.S. Cl. CPC G06F 3/04845; G06F 3/04817; H04L 51/52

(57) ABSTRACT

A content sharing method and apparatus, an electronic device, and a readable storage medium are provided. The content sharing method includes: displaying an application interface of a target session application; associating, in response to a first input to at least one session object identifier in the application interface, a session object corresponding to the at least one session object identifier with a sharing control; and sharing, in response to a second input to a content sharing interface via the sharing control, interface content of the content sharing interface with the session object corresponding to the at least one session object identifier.

### CROSS-REFERENCE TO RELATED APPLICATIONS

The application is a continuation of International Application No. PCT/CN2023/132896, filed on Nov. 21, 2023, which claims priority to Chinese Patent Application No. 202211490278.2, filed on Nov. 25, 2022. The entire contents of each of the above-referenced applications are expressly incorporated herein by reference.

### TECHNICAL FIELD

This application pertains to the field of communication technologies, and specifically relates to a content sharing method and apparatus, an electronic device, and a readable storage medium.

### BACKGROUND

With development of communication technologies, a user often chats with another user by using social software. In a chat process, the user needs to share and forward content such as an image and a video.

In some examples, if a user needs to share a picture with another user, the user needs to select the picture from an album, tap “Share”, select a social application, and then select a contact, and can send the picture only after confirmation. The operations are complex.

### SUMMARY

Embodiments of this application provide a content sharing method and apparatus, an electronic device, and a readable storage medium to simplify steps of operations for sharing content by a user.

According to a first aspect, an embodiment of this application provides a content sharing method, including: displaying an application interface of a target session application; associating, in response to a first input to at least one session object identifier in the application interface, a session object corresponding to the at least one session object identifier with a sharing control; and sharing, in response to a second input to a content sharing interface via the sharing control, interface content of the content sharing interface with the session object corresponding to the at least one session object identifier.

According to a second aspect, an embodiment of this application provides a content sharing apparatus, including: a display module, configured to display an application interface of a target session application; a processing module, configured to associate, in response to a first input to at least one session object identifier in the application interface, a session object corresponding to the at least one session object identifier with a sharing control; and a sharing module, configured to share, in response to a second input to a content sharing interface via the sharing control, interface content of the content sharing interface with the session object corresponding to the at least one session object identifier.

According to a third aspect, an embodiment of this application provides an electronic device, including a processor and a memory. The memory stores a program or instructions capable of running on the processor. When the program or instructions are executed by the processor, the steps of the method according to the first aspect are implemented.

According to a fourth aspect, an embodiment of this application provides a readable storage medium. The readable storage medium stores a program or instructions. When the program or instructions are executed by a processor, the steps of the method according to the first aspect are implemented.

According to a fifth aspect, an embodiment of this application provides a chip. The chip includes a processor and a communication interface. The communication interface is coupled to the processor. The processor is configured to run a program or instructions to implement the steps of the method according to the first aspect.

According to a sixth aspect, an embodiment of this application provides a computer program product. The program product is stored in a storage medium. The program product is executed by at least one processor to implement the method according to the first aspect.

In the embodiments of this application, by performing the first input on the application interface of the target session application, the user can associate the at least one session object identifier in the application interface of the target session application with the sharing control, and display the sharing control in the content sharing interface. By performing the second input on the interface content in the content sharing interface via the sharing control, the user can conveniently forward the interface content in the content sharing interface to the session object corresponding to the session object identifier, thereby sharing the interface content. Therefore, in a process of sharing content by the user with another user, the user's operations in switching between a social application interface and another interface are reduced, and steps of operations for sharing the content by the user are simplified.

### BRIEF DESCRIPTION OF DRAWINGS

FIG. 1 is a schematic flowchart of a content sharing method according to an embodiment of this application;

FIG. 2 is a first schematic diagram of a display interface of an electronic device according to an embodiment of this application;

FIG. 3 is a second schematic diagram of a display interface of an electronic device according to an embodiment of this application;

FIG. 4 is a third schematic diagram of a display interface of an electronic device according to an embodiment of this application;

FIG. 5 is a fourth schematic diagram of a display interface of an electronic device according to an embodiment of this application;

FIG. 6 is a fifth schematic diagram of a display interface of an electronic device according to an embodiment of this application;

FIG. 7 is a sixth schematic diagram of a display interface of an electronic device according to an embodiment of this application;

FIG. 8 is a seventh schematic diagram of a display interface of an electronic device according to an embodiment of this application;

FIG. 9 is a schematic block diagram of a content sharing apparatus according to an embodiment of this application;

FIG. 10 is a block diagram of a structure of an electronic device according to an embodiment of this application; and

FIG. 11 is a schematic diagram of a hardware structure of an electronic device for implementing an embodiment of this application.

### DETAILED DESCRIPTION

The following clearly describes the technical solutions in the embodiments of this application with reference to the accompanying drawings in the embodiments of this application. Apparently, the described embodiments are only some rather than all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that the terms used in this way are interchangeable in appropriate circumstances, so that the embodiments of this application can be implemented in other orders than the order illustrated or described herein. In addition, objects distinguished by “first” and “second” usually fall within one class, and a quantity of objects is not limited. For example, there may be one or more first objects. In addition, the term “and/or” in the specification and claims indicates at least one of connected objects, and the character “/” generally represents an “or” relationship between associated objects.

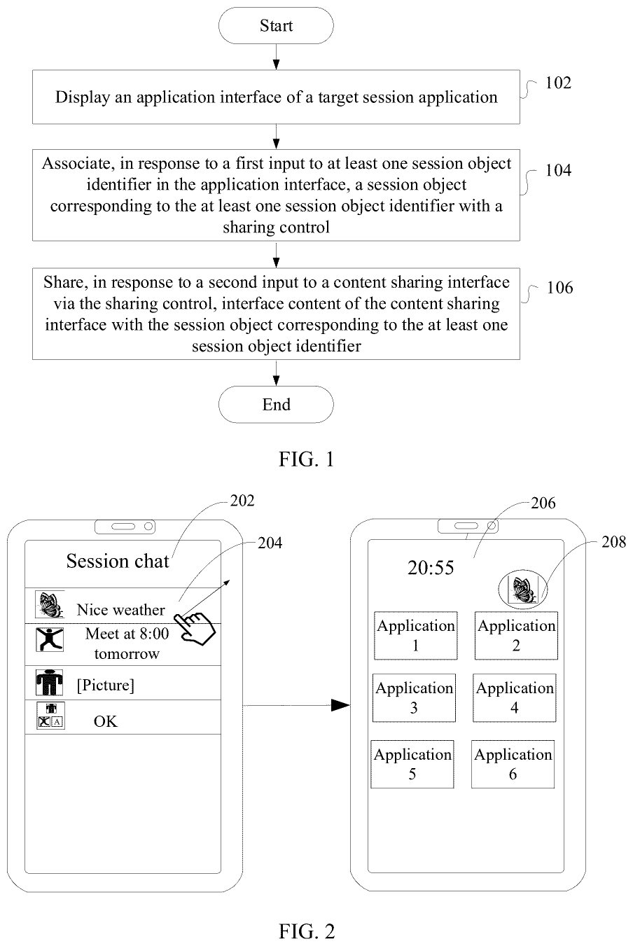

A content sharing method, a content sharing apparatus, an electronic device, and a storage medium provided in the embodiments of this application are hereinafter described in detail by using example embodiments and application scenarios thereof with reference to FIG. 1 to FIG. 11.

Some embodiments of this application provide a content sharing method. FIG. 1 is a schematic flowchart of a content sharing method according to an embodiment of this application. As shown in FIG. 1, assuming that the content sharing method is applied to an electronic device, the content sharing method includes the following steps.

Step 102: Display an application interface of a target session application.

In this embodiment of this application, the application interface of the target session application may be a session interface on which a user performs a session with another session object by using the target session application, and further, the session interface includes at least two session objects. In other words, the session interface may be a one-to-one chat interface between the user and another session object, or may be a group chat interface between the user and a plurality of other session objects.

Step 104: Associate, in response to a first input to at least one session object identifier in the application interface, a session object corresponding to the at least one session object identifier with a sharing control.

In this embodiment of this application, the first input is an operation input performed by the user on the at least one session object identifier in the application interface, and the first input is used to control the electronic device to associate the sharing control with the at least one session object identifier corresponding to the first input, so that the user can subsequently share other content with the session object corresponding to the session object identifier via the sharing control. In this embodiment of this application, after receiving the first input performed by the user on the at least one session object identifier in the application interface of the target session application, the electronic device displays the sharing control in the content sharing interface. The content sharing interface may be a display interface different from the application interface. For example, the content sharing interface may be a main interface of the electronic device, or may be an interface corresponding to another application.

For example, in a case that the user performs the first input on the at least one session object identifier in the application interface, the electronic device switches to displaying the main interface, and displays the sharing control in the main interface. The sharing control is associated with the at least one session object identifier corresponding to the first input, and the main interface further includes another operation control and an application icon.

FIG. 2 is a first schematic diagram of a display interface of an electronic device according to an embodiment of this application. As shown in FIG. 2, in a case that the electronic device displays a session interface 202, the user drags a session window 204 in the session interface 202 to a screen edge, where the session interface 202 is an application interface, the session window 204 is a session object identifier, and an input of the operation of dragging to the screen edge is equivalent to a first input performed by the user on the session interface. The electronic device switches from displaying the session interface 202 to displaying a main interface 206, where the main interface 206 displays a floating window 208 related to the session window 204. The main interface 206 is a content sharing interface, and the floating window 208 is a sharing control.

Step 106: Share, in response to a second input to a content sharing interface via the sharing control, interface content of the content sharing interface with the session object corresponding to the at least one session object identifier.

In this embodiment of this application, the interface content of the content sharing interface is display content other than the sharing control in the content sharing interface, and the interface content includes any one of the following: an application icon, an image file, a text document, and the like.

The second input is an operation input performed by the user on the content sharing interface via the sharing control, and the second input may be dragging the sharing control to the interface content, or the second input may be dragging the interface content to the sharing control, or the second input may be synchronously tapping “Share” and the interface content.

In this embodiment of this application, the sharing control is generated based on the first input of the user to the at least one session object in the application interface of the target session application. Therefore, the sharing control is associated with the at least one session object, and the shared content can be shared via the sharing control with the session object associated with the at least one session object. In a case that the first input points to a group chat window, there are a plurality of session object identifiers. In a case that the first input points to a single-person chat window, there is one session object identifier. After the electronic device receives the second input of the user to the interface content via the sharing control, the electronic device can determine the at least one corresponding session object based on the at least one session object identifier corresponding to the sharing control, and forward the interface content of the content sharing interface to a target session object, to implement quick forwarding of the interface content of the content sharing interface.

The target session object may be a separate contact, or may be a session group including a plurality of contacts. The interface content of the content sharing interface may be sent to the target session object as a link, or may be sent to the target session object as a screenshot, or may be sent to the target session object by retaining an original file format.

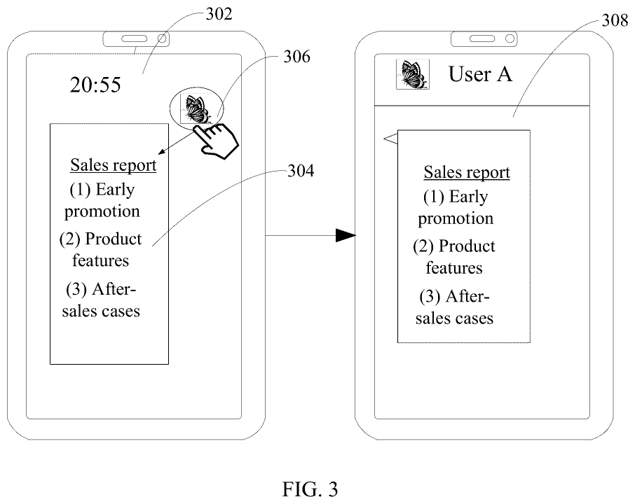

FIG. 3 is a second schematic diagram of a display interface of an electronic device according to an embodiment of this application. As shown in FIG. 3, the electronic device displays a first document 304 in a display interface 302 of a document application, and the display interface 302 further displays a floating window 306, where the floating window 306 is a sharing control, and the first document 304 is interface content of a content sharing interface. The user drags the floating window 306 to the first document 304, and the dragging input is equivalent to a second input performed by the user on the interface content of the content sharing interface via the sharing control. The electronic device switches from the display interface 302 to an application interface 308 of the target session application, and shares the first document 304 to a session window of the session object corresponding to the sharing control.

In this embodiment of this application, by performing the first input on the application interface of the target session application, the user can associate the at least one session object identifier in the application interface of the target session application with the sharing control, and display the sharing control in the content sharing interface. By performing the second input on the interface content in the content sharing interface via the sharing control, the user can conveniently forward the interface content in the content sharing interface to the session object corresponding to the session object identifier, thereby sharing the interface content. The content sharing interface is a page on which the interface content to be forwarded by the user is located, and the sharing control is associated with the session object corresponding to the session object identifier. After selecting the session object identifier in the application interface of the target session application and then selecting the interface content that needs to be forwarded in the content sharing interface, the user can forward the interface content to the target session object. Therefore, in a process of sharing content by the user with another user, the user's operations in switching between a social application interface and another interface are reduced, and steps of operations for sharing the content by the user are simplified.

In some embodiments of this application, the sharing control is associated with session objects corresponding to at least two session object identifiers, and the sharing control displays sharing object identifiers corresponding to at least two session objects;
before the step of sharing, in response to a second input to a content sharing interface via the sharing control, interface content of the content sharing interface with the session object corresponding to the at least one session object identifier, the method further includes:
using, in response to a third input to a first sharing object identifier of at least two sharing object identifiers displayed in the sharing control, a first session object corresponding to the first sharing object identifier as a current sharing object; and the sharing, in response to a second input to a content sharing interface via the sharing control, interface content of the content sharing interface with the session object corresponding to the at least one session object identifier includes:
sharing the interface content of the content sharing interface with the current sharing object in response to the second input to the content sharing interface via the sharing control.

In this embodiment of this application, the sharing control is associated with the session objects corresponding to the at least two session object identifiers, and the sharing control can display the sharing object identifiers corresponding to the at least two session objects, where different sharing object identifiers correspond to different session objects.

For example, the at least two sharing object identifiers may be displayed on a same screen in the sharing control.

For example, only one sharing object identifier is displayed in the sharing control at a time, and the sharing control switches, based on a preset time interval, between different sharing object identifiers displayed in the sharing control.

After the user performs the first input on the session object identifier in the application interface of the target session application, the electronic device displays, in response to the first input, a corresponding sharing object identifier in the sharing control based on the session object identifier in the application interface of the target session application. In a case that there are a plurality of session object identifiers, there are also a plurality of sharing object identifiers displayed in the sharing control, and the sharing object identifiers are in a one-to-one correspondence with the session object identifiers corresponding to the first input.

In a case that the sharing control displays the at least two sharing object identifiers, the user can perform the third input on the first sharing object identifier of the at least two sharing object identifiers to select the first session object corresponding to the first sharing object identifier as the current sharing object, and after the user performs the second input on the content sharing interface via the sharing control, share the interface content of the content sharing interface with the current sharing object.

The first session object may be a single contact, or may be a chat group including a plurality of contacts. The first sharing object identifier may be a profile picture icon, a group chat identifier, identity information, or the like of the session object.

For example, there may be one or more first sharing object identifiers. In a case that the user performs the third input on a plurality of first sharing object identifiers of the at least two sharing object identifiers, all first session objects corresponding to the plurality of first sharing object identifiers are used as current sharing objects. In a case that the user performs the second input on the content sharing interface via the sharing control, the interface content of the content sharing interface is synchronously shared with the plurality of current sharing objects.

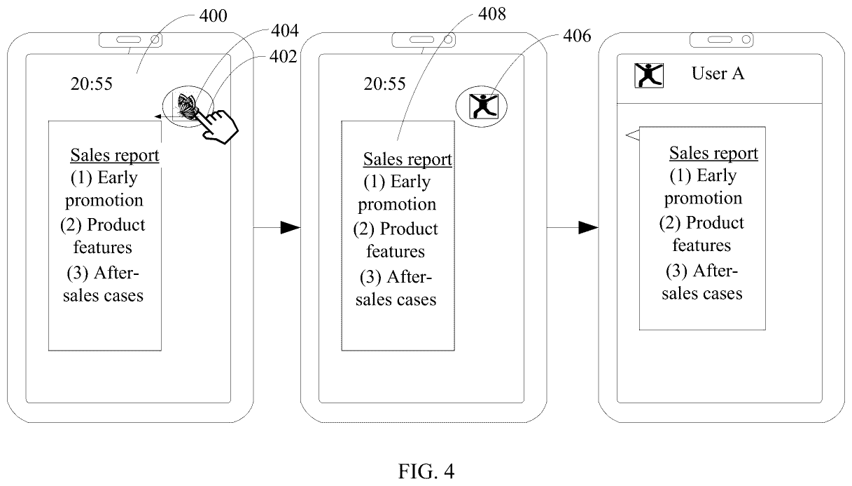

FIG. 4 is a third schematic diagram of a display interface of an electronic device according to an embodiment of this application. As shown in FIG. 4, the electronic device displays a floating window 402 in a content sharing interface 400, and the floating window 402 displays a profile picture icon 404, where the floating window 402 is a sharing control, and the profile picture icon 404 is a sharing object identifier. The user can switch the displayed profile picture icon 404 by left-sliding or right-sliding the profile picture icon 404 displayed in the floating window 402, to adjust a first sharing object identifier associated with the sharing control. After a first sharing object identifier 406 is selected, the electronic device determines a session object corresponding to the first sharing object identifier 406 as a current sharing object, and the user shares document content 408 with the current sharing object by dragging the floating window 402 to the document content 408.

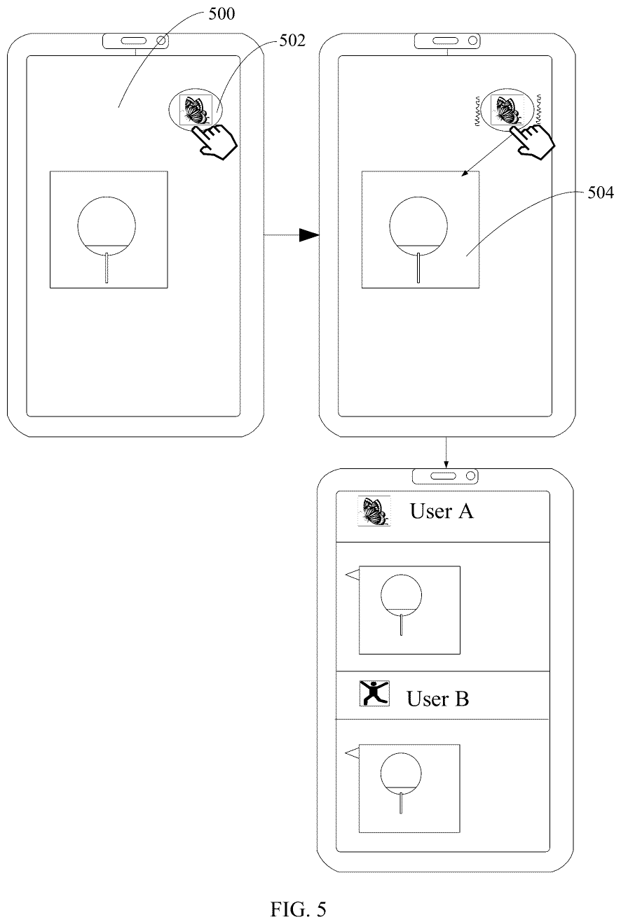

FIG. 5 is a fourth schematic diagram of a display interface of an electronic device according to an embodiment of this application. As shown in FIG. 5, the electronic device displays a floating window 502 and a picture file 504 in a content sharing interface 500, and the floating window 502 displays a plurality of icon identifiers. The user touches and holds the plurality of icon identifiers in the floating window 502 to use all of a plurality of session objects as current sharing objects. In this case, the floating window 502 displays a trembling special effect, to prompt the user that all sharing object identifiers are selected as first sharing object identifiers. The user drags the picture file 504 to the floating window 502, and sends the picture file 504 to the current sharing objects corresponding to the plurality of first sharing object identifiers.

In this embodiment of this application, when the sharing control corresponds to a plurality of different session objects, the user can select a current sharing object from the plurality of session objects by performing the third input. After the current sharing object is selected, the second input is performed on the interface content of the content sharing interface via the sharing control, and the interface content is sent to the current sharing object. In a case that the sharing control is associated with the plurality of session objects, the user can select the current sharing object only by performing the third input on the first sharing object identifier of the plurality of sharing object identifiers corresponding to the plurality of session objects. Therefore, fast and convenient switching of the current sharing object is implemented, and steps of operations for switching the current sharing object by the user are simplified.

In some embodiments of this application, after the step of sharing the interface content of the content sharing interface with the current sharing object in response to the second input to the content sharing interface via the sharing control, the method further includes:
displaying, in response to a fourth input to the first sharing object identifier displayed in the sharing control, historically shared content corresponding to the first sharing object identifier; and
sharing, in response to a fifth input to a second sharing object identifier displayed in the sharing control, the historically shared content with a second session object corresponding to the second sharing object identifier.

In this embodiment of this application, after the interface content of the content sharing interface is shared with the current sharing object, the user can perform the fourth input on the first sharing object identifier displayed in the sharing control, so that the electronic device displays the content historically shared with the session object corresponding to the first sharing object identifier. The historically shared content includes all shared content shared by the user with the session object corresponding to the first sharing object identifier. In a case that the historically shared content is displayed, the user performs the fifth input on the second sharing object identifier of the plurality of sharing object identifiers in the sharing control, so that the historically shared content can be forwarded again to the second session object corresponding to the second sharing object.

For example, in a case that the user needs to view the historically shared content corresponding to the first sharing object identifier, the user adjusts the first sharing object identifier displayed in the sharing control, and performs the fourth input on the first sharing object identifier. The electronic device displays, in response to the fourth input, the historically shared content corresponding to the first sharing object identifier. When the user needs to forward the historically shared content to the second session object again, the user performs the fifth input on the second sharing object identifier corresponding to the second session object in the sharing control, so that the sharing control is adjusted to switch from displaying the first sharing object identifier to displaying the second sharing object identifier, and the electronic device forwards the historically shared content to the second session object corresponding to the second sharing object identifier.

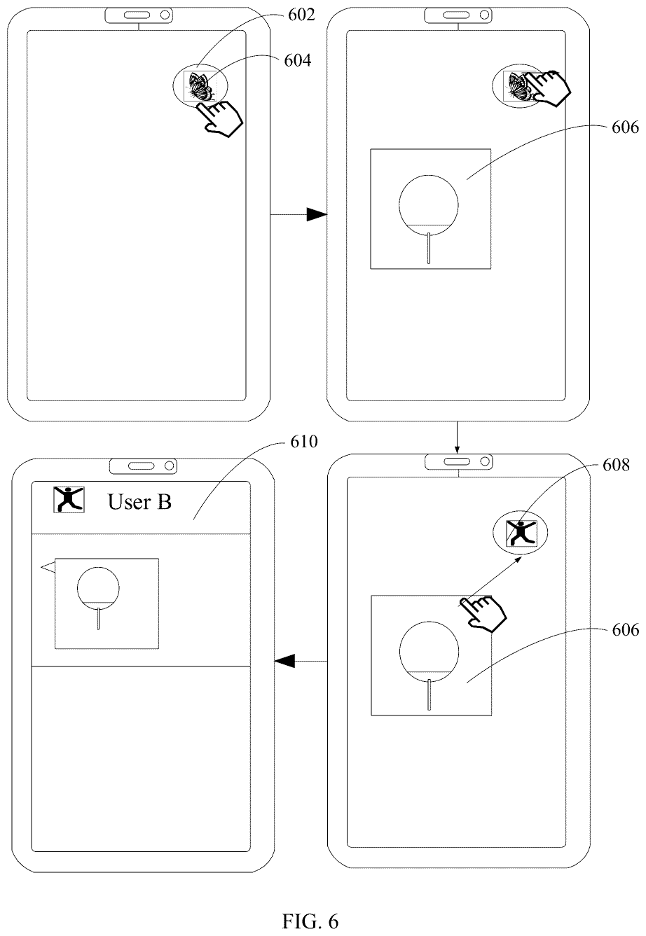

FIG. 6 is a sixth schematic diagram of a display interface of an electronic device according to an embodiment of this application. As shown in FIG. 6, the electronic device displays a floating window 602 in a content sharing interface, and the floating window 602 displays a first sharing object identifier 604. The user performs a double-tap input on the first sharing object identifier 604, where the double-tap input is a fourth input. The electronic device displays a first picture 606, and the first picture 606 is historically shared content corresponding to the first sharing object identifier 604. The user left-slides or right-slides the first sharing object identifier 604 in the floating window 602, so that the floating window 602 displays a second sharing object identifier 608. The user drags the first picture 606 to the second sharing object identifier 608 in the floating window 602, where the dragging input is a fifth input, and controls the electronic device to forward the first picture 606 to a third session object corresponding to the second sharing object identifier 608 in an application interface 610 of the target session application.

In this embodiment of this application, by operating the sharing control, the user can view the historically shared content corresponding to the first sharing object identifier, and perform the fifth input on the second sharing object identifier in the sharing control, so that the historically shared content is correspondingly quickly forwarded to the second session object corresponding to the second sharing object identifier. The user does not need to search a data source of social software or the historically shared content for the historically shared content. This simplifies steps of operations for forwarding the historically shared content shared by the user, and achieves an effect of quickly forwarding the historically shared content.

In some embodiments of this application, the session object corresponding to the at least one session object identifier includes a third session object, and the sharing control displays a third sharing object identifier corresponding to the third session object; and
after the step of sharing, in response to a second input to a content sharing interface via the sharing control, interface content of the content sharing interface with the session object corresponding to the at least one session object identifier, the method further includes:
associating, in response to a sixth input to a fourth session object identifier in the application interface, a fourth session object corresponding to the fourth session object identifier with the sharing control; and
in a case that a quantity of sharing object identifiers displayed in the sharing control is greater than a preset quantity, updating the third sharing object identifier displayed in the sharing control to a fourth sharing object identifier corresponding to the fourth session object.

In this embodiment of this application, to avoid difficulty for the user in finding a required current sharing object via the sharing control, an upper limit needs to be set on a quantity of session objects that can be associated with the sharing control. Setting a preset quantity of sharing object identifiers ensures that the user can quickly select the current sharing object from limited sharing object identifiers. For example, a value range of the preset quantity is 5 to 25.

In this embodiment of this application, after the user performs the sixth input on the fourth session object identifier in the application interface of the target session application, the fourth session object corresponding to the fourth session object identifier is associated with the sharing control. After the user associates the fourth session object with the sharing control, in a case that a quantity of sharing object identifiers displayed in the sharing control exceeds the preset quantity, the electronic device automatically replaces the third sharing object identifier corresponding to the third session object with the fourth sharing object identifier corresponding to the fourth session object. After the replacement, the user cannot share corresponding interface content with the third session object via the sharing control, and the user can share corresponding interface content with the fourth session object via the sharing control.

For example, the third sharing object identifier may be a sharing object identifier first associated with the sharing control. A maximum of five sharing object identifiers may be displayed in the sharing control. When the quantity of sharing object identifiers displayed in the sharing control reaches the upper limit, in a case that the user adds an associated sharing object to the sharing control, the third sharing object identifier first associated with the sharing control is replaced with the newly added fourth sharing object identifier.

For example, the third sharing object identifier is a sharing object identifier selected by the user from a plurality of sharing object identifiers in the sharing control. A maximum of five sharing object identifiers may be displayed in the sharing control. When the quantity of sharing object identifiers displayed in the sharing control reaches the upper limit, the user selects a third sharing object identifier that needs to be deleted. In a case that the user adds an associated sharing object identifier to the sharing control, the selected third sharing object identifier is replaced with the newly added fourth sharing object identifier.

In this embodiment of this application, in a case that the sharing control is already associated with session objects corresponding to the plurality of sharing object identifiers, the user can still add the fourth sharing object identifier to the sharing control. When the quantity of sharing object identifiers associated with the sharing control reaches the upper limit, the electronic device can replace the previously associated third sharing object identifier with the fourth sharing object identifier in response to the sixth input to the newly added fourth sharing object identifier, thereby achieving an effect that the user can replace and update, based on an actual requirement, the sharing object identifier associated with the sharing control.

In some embodiments of this application, the sharing, in response to a second input to a content sharing interface via the sharing control, interface content of the content sharing interface with the session object corresponding to the at least one session object identifier includes:
determining, in response to the second input to the content sharing interface via the sharing control, whether an input trajectory of the second input matches a preset trajectory; and
in a case that the input trajectory of the second input matches the preset trajectory, sharing the interface content of the content sharing interface with the session object corresponding to the at least one session object identifier.

In this embodiment of this application, the second input is a slide input of the user to drag the sharing control to the interface content of the content sharing interface. The preset trajectory is prestored in the electronic device, and the preset trajectory may be a slide trajectory preset by the user. When receiving the second input, the electronic device detects whether the input trajectory corresponding to the second input matches the preset trajectory, and when detecting that the input trajectory matches the preset trajectory, continues to perform an action of sharing the interface content, that is, sharing the interface content of the content sharing interface with the session object corresponding to the at least one session object identifier.

For example, that the input trajectory matches the preset trajectory may be that a trajectory shape of the input trajectory matches a trajectory shape of the preset trajectory.

For example, that the input trajectory matches the preset trajectory may be that both a trajectory shape and a trajectory size of the input trajectory match a trajectory shape and a trajectory size of the preset trajectory.

In this embodiment of this application, the electronic device updates a display position of the sharing control in the content sharing interface in real time based on the input trajectory of the second input, and displays a moving trajectory of the sharing control in the content sharing interface in real time. The user can confirm, by viewing the moving trajectory, whether the second input performed by the user is correct.

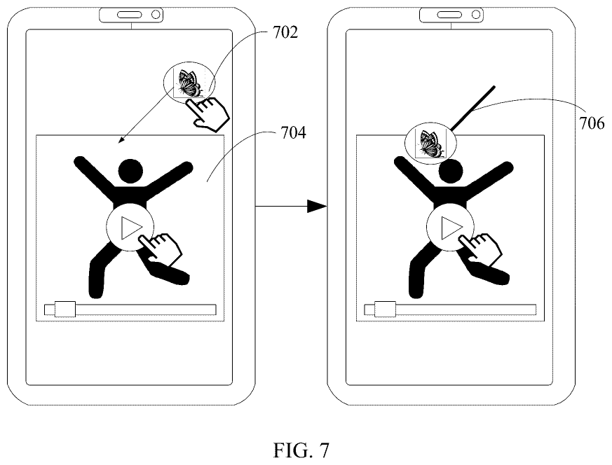

FIG. 7 is a sixth schematic diagram of a display interface of an electronic device according to an embodiment of this application. As shown in FIG. 7, the electronic device displays a floating window 702 and a video file 704 in a content sharing interface, where the floating window 702 is a sharing control, and the video file 704 is interface content in the content sharing interface. In a process in which the user drags the floating window 702 to the video file 704, the content sharing interface displays a moving trajectory 706 of the floating window 702.

In this embodiment of this application, the electronic device displays the moving trajectory of the sharing control in the content sharing interface, so that the user can learn a moving process of the sharing control.

In this embodiment of this application, the electronic device can detect the input trajectory of the second input, and in a case that it is detected that the input trajectory matches the preset trajectory, continue to perform the action of sharing the content, to avoid unintentional sharing caused by an unintentional touch of the user on the sharing control.

In some embodiments of this application, the sharing control is associated with session objects corresponding to at least two session object identifiers; and
the sharing, in response to a second input to a content sharing interface via the sharing control, interface content of the content sharing interface with the session object corresponding to the at least one session object identifier includes:
determining, in response to the second input to the content sharing interface via the sharing control, a fifth session object corresponding to an input trajectory of the second input; and
sharing the interface content of the content sharing interface with the fifth session object.

In this embodiment of this application, in a case that the sharing control is associated with the session objects corresponding to the at least two session object identifiers, a corresponding input trajectory is set for each session object. In a case that the second input performed by the user is received, the electronic device detects the input trajectory corresponding to the second input, determines a session object corresponding to a session object identifier that triggers the input trajectory to correspond to the input trajectory of the second input as the fifth session object, and shares the interface content of the content sharing interface with the fifth session object.

For example, when the sharing control is associated with two different session objects, the sharing control displays two different session object identifiers, and the user presets input trajectories corresponding to the two session objects, which are respectively an “S”-shaped first input trajectory corresponding to session object 1 and an “L”-shaped second input trajectory corresponding to session object 2. In a case that the user drags, in an “S” shape, the sharing control to the interface content of the content sharing interface, the user triggers sharing of the interface content with session object 1, or in a case that the user drags, in an “L” shape, the sharing control to the interface content of the content sharing interface, the user triggers sharing of the interface content with session object 2.

In this embodiment of this application, corresponding input trajectories are preset for a plurality of session objects associated with the sharing control, and the input trajectory of the second input performed by the user is detected, so that the electronic device can select the fifth session object from the plurality of session objects based on the input trajectory of the second input performed by the user and share the interface content of the content sharing interface with the fifth session object. Therefore, the user does not need to manually select an object with which the content is to be shared, and the user can select the content to be shared and the object with which the content needs to be shared, simultaneously by performing only one operation input. This further simplifies the steps of operations for sharing the content by the user.

In some embodiments of this application, the sharing, in response to a second input to a content sharing interface via the sharing control, interface content of the content sharing interface with the session object corresponding to the at least one session object identifier includes: determining a target screenshot image in response to the second input to the content sharing interface via the sharing control; and sharing the target screenshot image with the session object corresponding to the at least one session object identifier.

In this embodiment of this application, the interface content of the content sharing interface includes the target screenshot image corresponding to the content sharing interface. The user can obtain the target screenshot image by performing the second input on the content sharing interface via the sharing control, and share the target screenshot image with the session object corresponding to the at least one session object identifier, thereby sharing the interface content in the content sharing interface in a screenshot form.

For example, the second input includes a first sub-input and a second sub-input. The first sub-input is an operation input used to control the electronic device to take a screenshot of the interface content of the content sharing interface, and the second sub-input is an operation input used to control the electronic device to send a first screenshot to the session object corresponding to the at least one session object identifier.

Before the electronic device shares the content, the user can invoke a screenshot tool to take a screenshot of the interface content in the content sharing interface, and display a generated target screenshot image in the content sharing interface. The user performs an operation input on a target screenshot icon via the sharing control, and sends the target screenshot image to the session object corresponding to the at least one session object identifier.

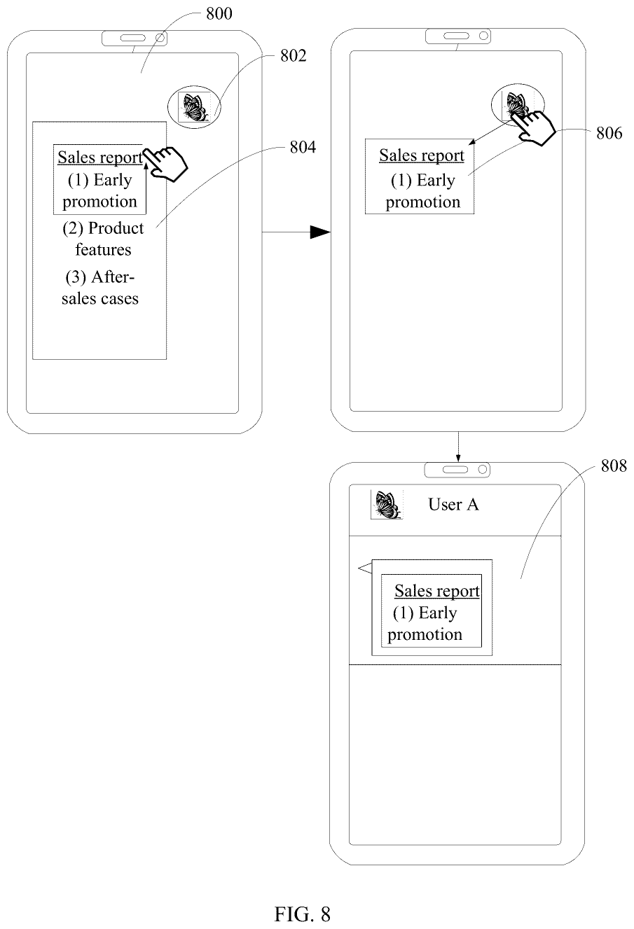

FIG. 8 is a seventh schematic diagram of a display interface of an electronic device according to an embodiment of this application. As shown in FIG. 8, the electronic device displays a floating window 802 and text content 804 in a content sharing interface 800, where the floating window 802 is a sharing control, and the text content 804 is interface content. The user triggers a screenshot operation on the text content 804 by selecting the text content 804 with a bounding box, and displays a first screenshot 806 in the content sharing interface 800, where a bounding box input performed by the user on the text content 804 is a first sub-input, the first screenshot 806 is a target screenshot image, the floating window 802 is a sharing control, and the text content 804 is interface content. The user drags the floating window 802 to the first screenshot 806, so that the first screenshot 806 is sent to a session object in an application interface 808 of the target session application, where the user's dragging input of dragging the floating window 802 is a second sub-input, and both the second sub-input and the first sub-input are sub-inputs of a second input.

In this embodiment of this application, when the user needs to share a screenshot of the interface content of the content sharing interface, the user controls the electronic device to display the sharing control in the content sharing interface in which the interface content is located, and take a screenshot of the interface content of the content sharing interface to obtain the target screenshot image. The user performs an operation input on the target screenshot image displayed in the content sharing interface and the sharing control to send the target screenshot image to the session object corresponding to the sharing control. In the process of sharing the screenshot of the content by the user, no frequent switching operation is required between a plurality of interfaces, thereby further simplifying steps of operations for sharing the screenshot of the content by the user.

In some embodiments of this application, the sharing, in response to a second input to a content sharing interface via the sharing control, interface content of the content sharing interface with the session object corresponding to the at least one session object identifier includes: determining a target sharing link in response to the second input to the content sharing interface via the sharing control; and sharing the target sharing link with the session object corresponding to the at least one session object identifier.

In this embodiment of this application, the interface content of the content sharing interface includes the target sharing link of the content sharing interface. The user performs the second input on the content sharing interface via the sharing control, and the electronic device can automatically generate the target sharing link of the content sharing interface and send the target sharing link to the session object corresponding to the at least one session object identifier.

After the session object corresponding to the session object identifier receives the target sharing link, the session object can perform an operation input on the target sharing link, so that an electronic device of the session object displays the content sharing interface.

For example, webpage content is displayed in the content sharing interface. After the user performs the second input on the content sharing interface via the sharing control, the electronic device automatically generates a target sharing link of the webpage content, and shares the target sharing link with the session object corresponding to the at least one session object identifier.

In this embodiment of this application, the user can share, in a form of a target sharing link, content displayed in the content sharing interface. This simplifies user operations and further reduces an amount of data transmitted in a sharing process.

The content sharing method provided in the embodiments of this application may be performed by a content sharing apparatus. A content sharing apparatus provided in the embodiments of this application is described by assuming that the content sharing method in the embodiments of this application is performed by the content sharing apparatus.

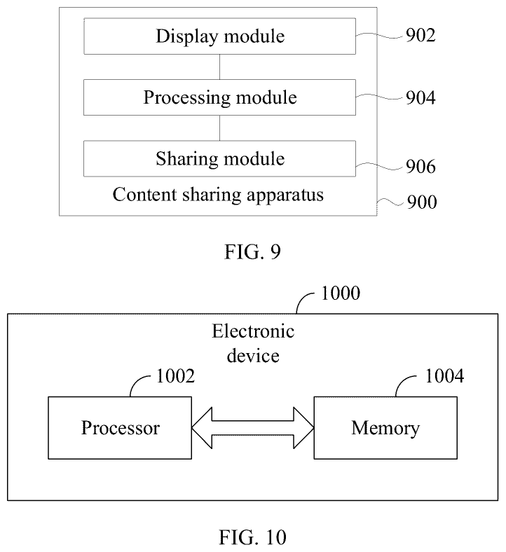

Some embodiments of this application provide a content sharing apparatus. FIG. 9 is a schematic block diagram of a content sharing apparatus according to an embodiment of this application. As shown in FIG. 9, the content sharing apparatus 900 includes:
a display module 902, configured to display an application interface of a target session application; a processing module 904, configured to associate, in response to a first input to at least one session object identifier in the application interface, a session object corresponding to the at least one session object identifier with a sharing control; and a sharing module 906, configured to share, in response to a second input to a content sharing interface via the sharing control, interface content of the content sharing interface with the session object corresponding to the at least one session object identifier.

In this embodiment of this application, by performing the first input on the application interface of the target session application, the user can associate the at least one session object identifier in the application interface of the target session application with the sharing control, and display the sharing control in the content sharing interface. By performing the second input on the interface content in the content sharing interface via the sharing control, the user can conveniently forward the interface content in the content sharing interface to the session object corresponding to the session object identifier, thereby sharing the interface content. Therefore, in a process of sharing content by the user with another user, the user's operations in switching between a social application interface and another interface are reduced, and steps of operations for sharing the content by the user are simplified.

In some embodiments of this application, the sharing control is associated with session objects corresponding to at least two session object identifiers, and the sharing control displays sharing object identifiers corresponding to at least two session objects; the processing module 904 is further configured to use, in response to a third input to a first sharing object identifier of at least two sharing object identifiers displayed in the sharing control, a first session object corresponding to the first sharing object identifier as a current sharing object; and the sharing module 906 is further configured to share the interface content of the content sharing interface with the current sharing object in response to the second input to the content sharing interface via the sharing control.

In this embodiment of this application, when the sharing control corresponds to a plurality of different session objects, the user can select a current sharing object from the plurality of session objects by performing the third input. After the current sharing object is selected, the second input is performed on the interface content of the content sharing interface via the sharing control, and the interface content is sent to the current sharing object. In a case that the sharing control is associated with the plurality of session objects, the user can select the current sharing object only by performing the third input on the first sharing object identifier of the plurality of sharing object identifiers corresponding to the plurality of session objects. Therefore, fast and convenient switching of the current sharing object is implemented, and steps of operations for switching the current sharing object by the user are simplified.

In some embodiments of this application, the display module 902 is configured to display, in response to a fourth input to the first sharing object identifier displayed in the sharing control, historically shared content corresponding to the first sharing object identifier; and the sharing module 906 is further configured to share, in response to a fifth input to a second sharing object identifier displayed in the sharing control, the historically shared content with a second session object corresponding to the second sharing object identifier.

In this embodiment of this application, by operating the sharing control, the user can view the historically shared content corresponding to the first sharing object identifier, and perform the fifth input on the second sharing object identifier in the sharing control, so that the historically shared content is correspondingly quickly forwarded to the second session object corresponding to the second sharing object identifier. The user does not need to search a data source of social software or the historically shared content for the historically shared content. This simplifies steps of operations for forwarding the historically shared content shared by the user, and achieves an effect of quickly forwarding the historically shared content.

In some embodiments of this application, the session object corresponding to the at least one session object identifier includes a third session object, and the sharing control displays a third sharing object identifier corresponding to the third session object; the processing module 904 is further configured to associate, in response to a sixth input to a fourth session object identifier in the application interface, a fourth session object corresponding to the fourth session object identifier with the sharing control; and in a case that a quantity of sharing object identifiers displayed in the sharing control is greater than a preset quantity, the display module 902 is further configured to update the third sharing object identifier displayed in the sharing control to a fourth sharing object identifier corresponding to the fourth session object.

In this embodiment of this application, in a case that the sharing control is already associated with session objects corresponding to the plurality of sharing object identifiers, the user can still add the fourth sharing object identifier to the sharing control. When the quantity of sharing object identifiers associated with the sharing control reaches the upper limit, the electronic device can replace the previously associated third sharing object identifier with the fourth sharing object identifier in response to the sixth input to the newly added fourth sharing object identifier, thereby achieving an effect that the user can replace and update, based on an actual requirement, the sharing object identifier associated with the sharing control.

In some embodiments of this application, the processing module 904 is further configured to determine, in response to the second input to the content sharing interface via the sharing control, whether an input trajectory of the second input matches a preset trajectory; and in a case that the input trajectory of the second input matches the preset trajectory, the sharing module 906 is further configured to share the interface content of the content sharing interface with the session object corresponding to the at least one session object identifier.

In this embodiment of this application, the electronic device can detect the input trajectory of the second input, and in a case that it is detected that the input trajectory matches the preset trajectory, continue to perform the action of sharing the content, to avoid unintentional sharing caused by an unintentional touch of the user on the sharing control.

In some embodiments of this application, the sharing control is associated with session objects corresponding to at least two session object identifiers; the processing module 904 is further configured to determine, in response to the second input to the content sharing interface via the sharing control, a fifth session object corresponding to an input trajectory of the second input; and the sharing module 906 is further configured to share the interface content of the content sharing interface with the fifth session object.

In this embodiment of this application, corresponding input trajectories are preset for a plurality of session objects associated with the sharing control, and the input trajectory of the second input performed by the user is detected, so that the electronic device can select the fifth session object from the plurality of session objects based on the input trajectory of the second input performed by the user and share the interface content of the content sharing interface with the fifth session object. Therefore, the user does not need to manually select an object with which the content is to be shared, and the user can select the content to be shared and the object with which the content needs to be shared, simultaneously by performing only one operation input. This further simplifies the steps of operations for sharing the content by the user.

In some embodiments of this application, the processing module 904 is further configured to determine a target screenshot image in response to the second input to the content sharing interface via the sharing control; and the sharing module 906 is further configured to share the target screenshot image with the session object corresponding to the at least one session object identifier.

In this embodiment of this application, when the user needs to share a screenshot of the interface content of the content sharing interface, the user controls the electronic device to display the sharing control in the content sharing interface in which the interface content is located, and take a screenshot of the interface content of the content sharing interface to obtain the target screenshot image. The user performs an operation input on the target screenshot image displayed in the content sharing interface and the sharing control to send the target screenshot image to the session object corresponding to the sharing control. In the process of sharing the screenshot of the content by the user, no frequent switching operation is required between a plurality of interfaces, thereby further simplifying steps of operations for sharing the screenshot of the content by the user.

In some embodiments of this application, the processing module 904 is further configured to determine a target sharing link in response to the second input to the content sharing interface via the sharing control; and the sharing module 906 is further configured to share the target sharing link with the session object corresponding to the at least one session object identifier.

In this embodiment of this application, the user can share, in a form of a target sharing link, content displayed in the content sharing interface. This simplifies user operations and further reduces an amount of data transmitted in a sharing process.

The content sharing apparatus in this embodiment of this application may be an electronic device, or may be a component such as an integrated circuit or a chip in an electronic device. The electronic device may be a terminal, or may be other devices than a terminal. For example, the electronic device may be a mobile phone, a tablet personal computer, a notebook computer, a palmtop computer, an in-vehicle electronic device, a Mobile Internet Device (MID), an augmented reality (AR) or virtual reality (VR) device, a robot, a wearable device, an ultra-mobile personal computer (UMPC), a netbook, a personal digital assistant (PDA), or the like; or the electronic device may be a server, a Network Attached Storage (NAS), a personal computer (PC), a television (TV), a teller machine, a self-service machine, or the like. This is not specifically limited in this embodiment of this application.

The content sharing apparatus in this embodiment of this application may be an apparatus with an operating system. The operating system may be an Android operating system, an iOS operating system, or other possible operating systems, and is not specifically limited in this embodiment of this application.

The content sharing apparatus provided in this embodiment of this application is capable of implementing each process implemented in the foregoing method embodiment. To avoid repetition, details are not described herein again.

For example, an embodiment of this application further provides an electronic device. The electronic device includes the content sharing apparatus in any one of the foregoing embodiments, and therefore has all beneficial effects of the content sharing apparatus in any one of the embodiments. Details are not described herein again.

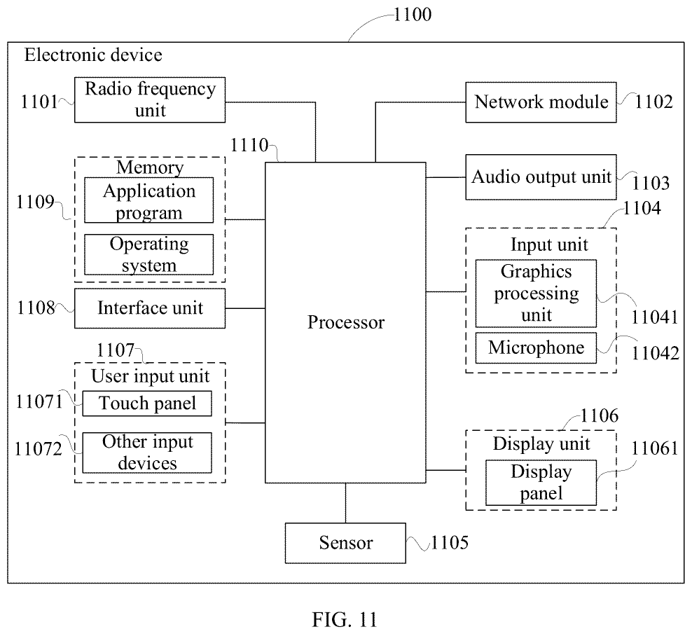

For example, an embodiment of this application further provides an electronic device. FIG. 10 is a block diagram of a structure of an electronic device according to an embodiment of this application. As shown in FIG. 10, the electronic device 1000 includes a processor 1002, a memory 1004, and a program or instructions stored in the memory 1004 and capable of running on the processor 1002. When the program or instructions are executed by the processor 1002, each process of the foregoing embodiment of the content sharing method is implemented, with the same technical effect achieved. To avoid repetition, details are not described herein again.

It should be noted that electronic devices in this embodiment of this application include the foregoing mobile electronic device and a nonmobile electronic device.

FIG. 11 is a schematic diagram of a hardware structure of an electronic device for implementing an embodiment of this application.

The electronic device 1100 includes but is not limited to components such as a radio frequency unit 1101, a network module 1102, an audio output unit 1103, an input unit 1104, a sensor 1105, a display unit 1106, a user input unit 1107, an interface unit 1108, a memory 1109, and a processor 1110.

A person skilled in the art may understand that the electronic device 1100 may further include a power supply (such as a battery) for supplying power to the components. The power supply may be logically connected to the processor 1110 through a power management system. In this way, functions such as charge management, discharge management, and power consumption management are implemented by using the power management system. The structure of the electronic device shown in FIG. 11 does not constitute a limitation on the electronic device. The electronic device may include more or fewer components than those shown in the figure, or some components are combined, or component arrangements are different. Details are not described herein again.

The display unit 1106 is configured to display an application interface of a target session application.

The processor 1110 is configured to associate, in response to a first input to at least one session object identifier in the application interface, a session object corresponding to the at least one session object identifier with a sharing control.

The processor 1110 is configured to share, in response to a second input to a content sharing interface via the sharing control, interface content of the content sharing interface with the session object corresponding to the at least one session object identifier.

In this embodiment of this application, by performing the first input on the application interface of the target session application, the user can associate the at least one session object identifier in the application interface of the target session application with the sharing control, and display the sharing control in the content sharing interface. By performing the second input on the interface content in the content sharing interface via the sharing control, the user can conveniently forward the interface content in the content sharing interface to the session object corresponding to the session object identifier, thereby sharing the interface content. Therefore, in a process of sharing content by the user with another user, the user's operations in switching between a social application interface and another interface are reduced, and steps of operations for sharing the content by the user are simplified.

Further, the sharing control is associated with session objects corresponding to at least two session object identifiers, and the sharing control displays sharing object identifiers corresponding to at least two session objects; the processor 1110 is further configured to use, in response to a third input to a first sharing object identifier of at least two sharing object identifiers displayed in the sharing control, a first session object corresponding to the first sharing object identifier as a current sharing object; and the processor 1110 is further configured to share the interface content of the content sharing interface with the current sharing object in response to the second input to the content sharing interface via the sharing control.

In this embodiment of this application, when the sharing control corresponds to a plurality of different session objects, the user can select a current sharing object from the plurality of session objects by performing the third input. After the current sharing object is selected, the second input is performed on the interface content of the content sharing interface via the sharing control, and the interface content is sent to the current sharing object. In a case that the sharing control is associated with the plurality of session objects, the user can select the current sharing object only by performing the third input on the first sharing object identifier of the plurality of sharing object identifiers corresponding to the plurality of session objects. Therefore, fast and convenient switching of the current sharing object is implemented, and steps of operations for switching the current sharing object by the user are simplified.

Further, the display unit 1106 is configured to display, in response to a fourth input to the first sharing object identifier displayed in the sharing control, historically shared content corresponding to the first sharing object identifier; and the processor 1110 is further configured to share, in response to a fifth input to a second sharing object identifier displayed in the sharing control, the historically shared content with a second session object corresponding to the second sharing object identifier.

In this embodiment of this application, by operating the sharing control, the user can view the historically shared content corresponding to the first sharing object identifier, and perform the fifth input on the second sharing object identifier in the sharing control, so that the historically shared content is correspondingly quickly forwarded to the second session object corresponding to the second sharing object identifier. The user does not need to search a data source of social software or the historically shared content for the historically shared content. This simplifies steps of operations for forwarding the historically shared content shared by the user, and achieves an effect of quickly forwarding the historically shared content.

Further, the session object corresponding to the at least one session object identifier includes a third session object, and the sharing control displays a third sharing object identifier corresponding to the third session object; the processor 1110 is further configured to associate, in response to a sixth input to a fourth session object identifier in the application interface, a fourth session object corresponding to the fourth session object identifier with the sharing control; and
in a case that a quantity of sharing object identifiers displayed in the sharing control is greater than a preset quantity, the display unit 1106 is further configured to update the third sharing object identifier displayed in the sharing control to a fourth sharing object identifier corresponding to the fourth session object.

In this embodiment of this application, in a case that the sharing control is already associated with session objects corresponding to the plurality of sharing object identifiers, the user can still add the fourth sharing object identifier to the sharing control. When the quantity of sharing object identifiers associated with the sharing control reaches the upper limit, the electronic device can replace the previously associated third sharing object identifier with the fourth sharing object identifier in response to the sixth input to the newly added fourth sharing object identifier, thereby achieving an effect that the user can replace and update, based on an actual requirement, the sharing object identifier associated with the sharing control.

Further, the processor 1110 is further configured to determine, in response to the second input to the content sharing interface via the sharing control, whether an input trajectory of the second input matches a preset trajectory; and in a case that the input trajectory of the second input matches the preset trajectory, the processor 1110 is further configured to share the interface content of the content sharing interface with the session object corresponding to the at least one session object identifier.

In this embodiment of this application, the electronic device can detect the input trajectory of the second input, and in a case that it is detected that the input trajectory matches the preset trajectory, continue to perform the action of sharing the content, to avoid unintentional sharing caused by an unintentional touch of the user on the sharing control.

Further, the sharing control is associated with session objects corresponding to at least two session object identifiers; the processor 1110 is further configured to determine, in response to the second input to the content sharing interface via the sharing control, a fifth session object corresponding to an input trajectory of the second input; and the processor 1110 is further configured to share the interface content of the content sharing interface with the fifth session object.

In this embodiment of this application, corresponding input trajectories are preset for a plurality of session objects associated with the sharing control, and the input trajectory of the second input performed by the user is detected, so that the electronic device can select the fifth session object from the plurality of session objects based on the input trajectory of the second input performed by the user and share the interface content of the content sharing interface with the fifth session object. Therefore, the user does not need to manually select an object with which the content is to be shared, and the user can select the content to be shared and the object with which the content needs to be shared, simultaneously by performing only one operation input. This further simplifies the steps of operations for sharing the content by the user.

Further, the processor 1110 is further configured to determine a target screenshot image in response to the second input to the content sharing interface via the sharing control; and the processor 1110 is further configured to share the target screenshot image with the session object corresponding to the at least one session object identifier.

In this embodiment of this application, when the user needs to share a screenshot of the interface content of the content sharing interface, the user controls the electronic device to display the sharing control in the content sharing interface in which the interface content is located, and take a screenshot of the interface content of the content sharing interface to obtain the target screenshot image. The user performs an operation input on the target screenshot image displayed in the content sharing interface and the sharing control to send the target screenshot image to the session object corresponding to the sharing control. In the process of sharing the screenshot of the content by the user, no frequent switching operation is required between a plurality of interfaces, thereby further simplifying steps of operations for sharing the screenshot of the content by the user.

Further, the processor 1110 is further configured to determine a target sharing link in response to the second input to the content sharing interface via the sharing control; and the processor 1110 is further configured to share the target sharing link with the session object corresponding to the at least one session object identifier.

In this embodiment of this application, the user can share, in a form of a target sharing link, content displayed in the content sharing interface. This simplifies user operations and further reduces an amount of data transmitted in a sharing process.

It should be understood that, in this embodiment of this application, the input unit 1104 may include a Graphics Processing Unit (GPU) 11041 and a microphone 11042. The graphics processing unit 11041 processes image data of a still picture or video obtained by an image capture apparatus (such as a camera) in a video capture mode or an image capture mode. The display unit 1106 may include a display panel 11061, and the display panel 11061 may be configured in a form of a liquid crystal display, an organic light-emitting diode, or the like. The user input unit 1107 includes at least one of a touch panel 11071 and other input devices 11072. The touch panel 11071 is also referred to as a touchscreen. The touch panel 11071 may include two parts: a touch detection apparatus and a touch controller. The other input devices 11072 may include but are not limited to a physical keyboard, a function button (such as a volume control button or a power button), a trajectory ball, a mouse, and a joystick. Details are not described herein again.

The memory 1109 may be configured to store software programs and various data. The memory 1109 may primarily include a first storage area for storing programs or instructions and a second storage area for storing data. The first storage area may store an operating system, an application program or instructions required by at least one function (such as an audio play function and an image play function), and the like. In addition, the memory 1109 may include a volatile memory or a non-volatile memory, or the memory 1109 may include both a volatile memory and a non-volatile memory. The non-volatile memory may be a Read-Only Memory (ROM), a programmable read-only memory (PROM), an erasable programmable read-only memory (EPROM), an electrically erasable programmable read-only memory (EEPROM), or a flash memory. The volatile memory may be a Random Access Memory (RAM), a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), and a direct rambus random access memory (DRRAM). The memory 1109 in this embodiment of this application includes but is not limited to these and any other suitable types of memories.

The processor 1110 may include one or more processing units. For example, the processor 1110 integrates an application processor and a modem processor. The application processor mainly processes operations related to the operating system, a user interface, an application program, and the like. The modem processor mainly processes a wireless communication signal. For example, the modem processor is a baseband processor. It may be understood that the modem processor may, for example, not be integrated in the processor 1110.

An embodiment of this application further provides a readable storage medium. The readable storage medium stores a program or instructions. When the program or instructions are executed by a processor, each process of the foregoing method embodiment is implemented, with the same technical effect achieved. To avoid repetition, details are not described herein again.

The processor is the processor in the electronic device described in the foregoing embodiment. The readable storage medium includes a computer-readable storage medium, such as a computer read-only memory ROM, a random access memory RAM, a magnetic disk, or an optical disc.

In addition, an embodiment of this application provides a chip. The chip includes a processor and a communication interface. The communication interface is coupled to the processor. The processor is configured to run a program or instructions to implement each process of the foregoing embodiment of the content sharing method, with the same technical effect achieved. To avoid repetition, details are not described herein again.

It should be understood that the chip provided in this embodiment of this application may also be referred to as a system-level chip, a system chip, a chip system, a system-on-chip, or the like.

An embodiment of this application provides a computer program product. The program product is stored in a storage medium, and the program product is executed by at least one processor to implement each process of the foregoing embodiment of the content sharing method, with the same technical effect achieved. To avoid repetition, details are not described herein again.

It should be noted that in this specification, the term “comprise”, “include”, or any of their variants are intended to cover a non-exclusive inclusion, so that a process, a method, an article, or an apparatus that includes a list of elements not only includes those elements but also includes other elements that are not expressly listed, or further includes elements inherent to such process, method, article, or apparatus. In absence of more constraints, an element preceded by “includes a . . . ” does not preclude existence of other identical elements in the process, method, article, or apparatus that includes the element. In addition, it should be noted that the scope of the method and apparatus in the implementations of this application is not limited to performing the functions in an order shown or discussed, and may further include performing the functions in a substantially simultaneous manner or in a reverse order depending on the functions used. For example, the method described may be performed in an order different from that described, and various steps may be added, omitted, or combined. In addition, features described with reference to some examples may be combined in other examples.

According to the foregoing description of the implementations, a person skilled in the art may clearly understand that the methods in the foregoing embodiments may be implemented by using software in combination with a necessary general hardware platform, and may alternatively be implemented by using hardware. However, in most cases, the former is a preferred implementation. Based on such an understanding, the technical solutions of this application essentially or the part contributing to the prior art may be implemented in a form of a computer software product. The computer software product is stored in a storage medium (such as a ROM/RAM, a magnetic disk, or an optical disc), and includes several instructions for instructing a terminal (which may be a mobile phone, a computer, a server, a network device, or the like) to perform the methods described in the embodiments of this application.

The foregoing describes the embodiments of this application with reference to the accompanying drawings. However, this application is not limited to the foregoing specific embodiments. The foregoing specific embodiments are merely illustrative rather than restrictive. Inspired by this application, a person of ordinary skill in the art may develop many other manners without departing from principles of this application and the protection scope of the claims, and all such manners fall within the protection scope of this application.

1. A content sharing method, comprising:
displaying an application interface of a target session application;
associating, in response to a first input to at least one session object identifier in the application interface, a session object corresponding to the at least one session object identifier with a sharing control; and
sharing, in response to a second input to a content sharing interface via the sharing control, interface content of the content sharing interface with the session object corresponding to the at least one session object identifier.

2. The content sharing method according to claim 1, wherein the sharing control is associated with session objects corresponding to at least two session object identifiers, and the sharing control displays sharing object identifiers corresponding to at least two session objects;
wherein before sharing, in response to the second input to a content sharing interface via the sharing control, the interface content of the content sharing interface with the session object corresponding to the at least one session object identifier, the content sharing method further comprises:
using, in response to a third input to a first sharing object identifier of at least two sharing object identifiers displayed in the sharing control, a first session object corresponding to the first sharing object identifier as a current sharing object; and
wherein sharing, in response to the second input to the content sharing interface via the sharing control, the interface content of the content sharing interface with the session object corresponding to the at least one session object identifier comprises:
sharing the interface content of the content sharing interface with the current sharing object in response to the second input to the content sharing interface via the sharing control.

3. The content sharing method according to claim 2, wherein after sharing the interface content of the content sharing interface with the current sharing object in response to the second input to the content sharing interface via the sharing control, the content sharing method further comprises:
displaying, in response to a fourth input to the first sharing object identifier displayed in the sharing control, historically shared content corresponding to the first sharing object identifier; and
sharing, in response to a fifth input to a second sharing object identifier displayed in the sharing control, the historically shared content with a second session object corresponding to the second sharing object identifier.

4. The content sharing method according to claim 1, wherein the session object corresponding to the at least one session object identifier comprises a third session object, and the sharing control displays a third sharing object identifier corresponding to the third session object; and
wherein after sharing, in response to the second input to the content sharing interface via the sharing control, the interface content of the content sharing interface with the session object corresponding to the at least one session object identifier, the content sharing method further comprises:
associating, in response to a sixth input to a fourth session object identifier in the application interface, a fourth session object corresponding to the fourth session object identifier with the sharing control; and
when a quantity of sharing object identifiers displayed in the sharing control is greater than a preset quantity, updating the third sharing object identifier displayed in the sharing control to a fourth sharing object identifier corresponding to the fourth session object.

5. The content sharing method according to claim 1, wherein sharing, in response to the second input to the content sharing interface via the sharing control, the interface content of the content sharing interface with the session object corresponding to the at least one session object identifier comprises:
determining, in response to the second input to the content sharing interface via the sharing control, whether an input trajectory of the second input matches a preset trajectory; and
when the input trajectory of the second input matches the preset trajectory, sharing the interface content of the content sharing interface with the session object corresponding to the at least one session object identifier.

6. The content sharing method according to claim 1, wherein the sharing control is associated with session objects corresponding to at least two session object identifiers; and
wherein sharing, in response to the second input to the content sharing interface via the sharing control, the interface content of the content sharing interface with the session object corresponding to the at least one session object identifier comprises:
determining, in response to the second input to the content sharing interface via the sharing control, a fifth session object corresponding to an input trajectory of the second input; and
sharing the interface content of the content sharing interface with the fifth session object.

7. The content sharing method according to claim 1, wherein sharing, in response to the second input to the content sharing interface via the sharing control, the interface content of the content sharing interface with the session object corresponding to the at least one session object identifier comprises:
determining a target screenshot image in response to the second input to the content sharing interface via the sharing control; and
sharing the target screenshot image with the session object corresponding to the at least one session object identifier.

8. The content sharing method according to claim 1, wherein sharing, in response to the second input to the content sharing interface via the sharing control, the interface content of the content sharing interface with the session object corresponding to the at least one session object identifier comprises:
determining a target sharing link in response to the second input to the content sharing interface via the sharing control; and
sharing the target sharing link with the session object corresponding to the at least one session object identifier.

9. An electronic device, comprising:
a processor; and
a memory storing a program or instructions that, when executed by a processor, perform a content sharing method comprising:
displaying an application interface of a target session application;
associating, in response to a first input to at least one session object identifier in the application interface, a session object corresponding to the at least one session object identifier with a sharing control; and
sharing, in response to a second input to a content sharing interface via the sharing control, interface content of the content sharing interface with the session object corresponding to the at least one session object identifier.

10. The electronic device according to claim 9, wherein the sharing control is associated with session objects corresponding to at least two session object identifiers, and the sharing control displays sharing object identifiers corresponding to at least two session objects,
wherein before sharing, in response to the second input to the content sharing interface via the sharing control, the interface content of the content sharing interface with the session object corresponding to the at least one session object identifier, the content sharing method further comprises:
using, in response to a third input to a first sharing object identifier of at least two sharing object identifiers displayed in the sharing control, a first session object corresponding to the first sharing object identifier as a current sharing object, and
wherein sharing, in response to the second input to the content sharing interface via the sharing control, the interface content of the content sharing interface with the session object corresponding to the at least one session object identifier comprises:
sharing the interface content of the content sharing interface with the current sharing object in response to the second input to the content sharing interface via the sharing control.

11. The electronic device according to claim 10, wherein after sharing the interface content of the content sharing interface with the current sharing object in response to the second input to the content sharing interface via the sharing control, the content sharing method further comprises:
displaying, in response to a fourth input to the first sharing object identifier displayed in the sharing control, historically shared content corresponding to the first sharing object identifier; and
sharing, in response to a fifth input to a second sharing object identifier displayed in the sharing control, the historically shared content with a second session object corresponding to the second sharing object identifier.

12. The electronic device according to claim 9, wherein the session object corresponding to the at least one session object identifier comprises a third session object, and the sharing control displays a third sharing object identifier corresponding to the third session object, and
wherein after sharing, in response to the second input to the content sharing interface via the sharing control, the interface content of the content sharing interface with the session object corresponding to the at least one session object identifier, the content sharing method further comprises:
associating, in response to a sixth input to a fourth session object identifier in the application interface, a fourth session object corresponding to the fourth session object identifier with the sharing control; and
when a quantity of sharing object identifiers displayed in the sharing control is greater than a preset quantity, updating the third sharing object identifier displayed in the sharing control to a fourth sharing object identifier corresponding to the fourth session object.

13. The electronic device according to claim 9, wherein sharing, in response to the second input to the content sharing interface via the sharing control, the interface content of the content sharing interface with the session object corresponding to the at least one session object identifier comprises:
determining, in response to the second input to the content sharing interface via the sharing control, whether an input trajectory of the second input matches a preset trajectory; and
when the input trajectory of the second input matches the preset trajectory, sharing the interface content of the content sharing interface with the session object corresponding to the at least one session object identifier.

14. The electronic device according to claim 9, wherein the sharing control is associated with session objects corresponding to at least two session object identifiers, and
wherein sharing, in response to the second input to the content sharing interface via the sharing control, the interface content of the content sharing interface with the session object corresponding to the at least one session object identifier comprises:
determining, in response to the second input to the content sharing interface via the sharing control, a fifth session object corresponding to an input trajectory of the second input; and
sharing the interface content of the content sharing interface with the fifth session object.

15. The electronic device according to claim 9, wherein sharing, in response to the second input to the content sharing interface via the sharing control, the interface content of the content sharing interface with the session object corresponding to the at least one session object identifier comprises:
determining a target screenshot image in response to the second input to the content sharing interface via the sharing control; and
sharing the target screenshot image with the session object corresponding to the at least one session object identifier.

16. The electronic device according to claim 9, wherein sharing, in response to the second input to the content sharing interface via the sharing control, the interface content of the content sharing interface with the session object corresponding to the at least one session object identifier comprises:
determining a target sharing link in response to the second input to the content sharing interface via the sharing control; and
sharing the target sharing link with the session object corresponding to the at least one session object identifier.

17. A non-transitory computer-readable storage medium storing instructions that, when executed by a processor, cause the processor to perform operations comprising:
displaying an application interface of a target session application;
associating, in response to a first input to at least one session object identifier in the application interface, a session object corresponding to the at least one session object identifier with a sharing control; and
sharing, in response to a second input to a content sharing interface via the sharing control, interface content of the content sharing interface with the session object corresponding to the at least one session object identifier.

18. The non-transitory computer-readable storage medium according to claim 17, wherein the sharing control is associated with session objects corresponding to at least two session object identifiers, and the sharing control displays sharing object identifiers corresponding to at least two session objects,
wherein before sharing, in response to the second input to the content sharing interface via the sharing control, the interface content of the content sharing interface with the session object corresponding to the at least one session object identifier, the operations further comprise:
using, in response to a third input to a first sharing object identifier of at least two sharing object identifiers displayed in the sharing control, a first session object corresponding to the first sharing object identifier as a current sharing object, and
wherein sharing, in response to the second input to the content sharing interface via the sharing control, the interface content of the content sharing interface with the session object corresponding to the at least one session object identifier comprises:
sharing the interface content of the content sharing interface with the current sharing object in response to the second input to the content sharing interface via the sharing control.

19. The non-transitory computer-readable storage medium according to claim 18, wherein after sharing the interface content of the content sharing interface with the current sharing object in response to the second input to the content sharing interface via the sharing control, the operations further comprise:
displaying, in response to a fourth input to the first sharing object identifier displayed in the sharing control, historically shared content corresponding to the first sharing object identifier; and
sharing, in response to a fifth input to a second sharing object identifier displayed in the sharing control, the historically shared content with a second session object corresponding to the second sharing object identifier.

20. The non-transitory computer-readable storage medium according to claim 17, wherein the session object corresponding to the at least one session object identifier comprises a third session object, and the sharing control displays a third sharing object identifier corresponding to the third session object, and
wherein after sharing, in response to the second input to the content sharing interface via the sharing control, the interface content of the content sharing interface with the session object corresponding to the at least one session object identifier, the operations further comprise:
associating, in response to a sixth input to a fourth session object identifier in the application interface, a fourth session object corresponding to the fourth session object identifier with the sharing control; and
when a quantity of sharing object identifiers displayed in the sharing control is greater than a preset quantity, updating the third sharing object identifier displayed in the sharing control to a fourth sharing object identifier corresponding to the fourth session object.
